(19) United States
(12) Patent Application Publication
(10) Pub. No.: US 2006/0035018 A1
(43) Pub. Date: Feb. 16, 2006

(54) Method for forming a thin film silver mirror and method for forming coated film comprising thin silver mirror film

(75) Inventors: Akira Sakurai, SAKADO-SHI, SAITAMA (JP); Junichi Togasaki, Oura-gun (JP)

Correspondence Address: OLIFF & BERRIDGE, PLC, P.O. BOX 19928, ALEXANDRIA, VA, 22320, US

(73) Assignees: ADVANCE COMPANY, LTD., SAITAMA (JP); OHRA SANGYO CO., LTD., OURA-GUN, GUNMA (JP)

(21) Appl. No.: 10/533,546

(22) PCT Filed: Oct. 29, 2003
(86) PCT No.: PCT/JP03/13837

§ 371 Date: May 2, 2005

(30) Foreign Application Priority Data
Nov. 1, 2002 (JP) 2002-319580

(51) Int. Cl. B32B 15/04

(52) U.S. Cl. 427/162; 428/457

(57) ABSTRACT

In forming a thin film of silver mirror on a surface of an object to be coated, a silver mirror reaction-treating solution including three solutions: an ammoniacal silver salt aqueous solution (I), an aqueous solution of caustic soda (IIa) and an aqueous solution of a carbohydrate-based reducing agent (IIb) such as glucose (fructose) are used. Immediately after the caustic soda aqueous solution (IIa) and the reducing agent aqueous solution (IIb) are mixed, the resulting mixed liquid and the ammoniacal silver salt aqueous solution (I) are independently and simultaneously sprayed onto the object. Alternatively, the mixed liquid (II) and the ammoniacal silver salt aqueous solution (I) are mixed together immediately upstream of a spraying nozzle, and the mixed liquid (III) is sprayed onto the object. Thereby, a thin film of silver mirror is formed in a thickness of around 0.01 to 0.03 μm, for example, through depositing silver by a silver mirror reaction.

### TECHNICAL FIELD

The present invention relates to a method for forming a thin film of a silver mirror on a surface of an object to be coated, such as a resin molded product, and a method for forming a coated film containing said thin film of silver mirror.

Heretofore, metallic luster is afforded upon surfaces of resin molded products such as parts of automobiles, home electric appliances, etc. by metallic plating.

For example, an ABS resin-plating method has been already established. According to this plating method, minute holes are formed in a surface of an ABS resin-molded product with an etching solution containing sulfuric acid, the resulting molded product is subjected to a sensitizing treatment with an aqueous solution of tin chloride SnCl₂ and then to an activating treatment through being immersed into an aqueous solution of palladium chloride PdCl₂, and the resultant is made electroconductive by chemical Ni plating and thereafter electroplated with copper, nickel or chromium.

However, the coating technique accompanied with the ordinary plating treatment has a problem that it requires disposal of the used plating liquid to be severely controlled. Therefore, expansion of the coating lines in view of the future has not be desired.

Recently, a method is proposed for using a silver mirror reaction to afford metallic luster upon an object to be coated (For example, see JP-A 2001-46958). This publication discloses a method for forming a coated film having metallic luster upon a surface of a resin molded product. In this method for forming the coated film having the metallic luster, a paste solution containing a metal is sprayed onto the surface of a resinous object to be coated, an aqueous solution (A) containing metal ions such as silver ions and an aqueous solution (B) containing a reducing agent are simultaneously sprayed onto this surface, the metal is deposited by reducing the metal ions through the silver mirror reaction, an excess amount of the metal ions are washed away with pure water, and a clear coating is carried out after a specific fixing agent such sodium hydroxide is sprayed onto the resultant.

Here, an ammoniacal silver nitrate aqueous solution having a concentration of 0.1% to 15% is used as the aqueous solution (A) containing the metal ions.

Further, a silver surface-forming method is also known, which carries out an activating treatment by spraying an activating agent containing stannous chloride and a noble metal such as palladium with a spray and simultaneously sprays a metal salt-containing solution and a reducing agent-containing solution to constitute a sliver mirror reaction-treating agent with a spray (For example, see JP-A 11-335,858).

Herein, the solution containing a predetermined concentration of the metal salt is prepared by incorporating an aqueous solution of sodium hydroxide into a solution of silver nitrate added with ammonia, the reducing agent-containing solution is then prepared by adding formalin into an aqueous solution of tartaric acid and glucose, both the solutions constituting the silver mirror reaction-treating agent are separately stored in pressure feed tanks, respectively. These solutions are applied through simultaneous spraying with a double-headed gun, a double-gun unit or the like.

The above publication discloses that a high-grade decorated product as would be provided with colored luster by plating is obtained by spraying a transparent clear coating material or a transparent coloring coating material upon the silver surface.

In recent years, in order to cope with diversification in designs and differentiation in products, decorating techniques have been actively pursued for enhancing quality in appearances and giving superiority in market. Under the circumstances, attention has been focused upon plated light-transmitting products having a metallic appearance and light transmittance property. These plated light-transmitting products are produced by applying a thin film of a light-transmittable metal upon a surface of a base member made of a transparent or light-transmitting light-transmittable material.

However, a dry plating method such as a vacuum deposition method or a sputtering method is solely employed from the standpoint of view that the metallic thin film applied to plated light-transmitting product needs to be formed in such a sufficiently thin film as permitting transmission of light. Such a dry plating method unfavorably needs a high equipment cost. On the other hand, electroplating is a method which would be withheld from use in view of environmental problems.

Incidentally, if a silver thin film sufficiently thin as to permit transmission of light beams is formed by the decorated product-producing method utilizing the silver mirror reaction as conventionally proposed, the thus formed silver thin film is sometimes colored, or silver grains in the silver thin film are peeled to deteriorate durability. Thus, there was a problem that it is difficult to employ the conventional method for surface-treating automobile parts, etc. which require heat resistance and weather resistance.

### DISCLOSURE OF THE INVENTION

It is an object of the present invention to provide a silver mirror-thin film forming method adapted for forming a thin film of silver mirror being free from coloring and changes in color and having high durability even when a coated film is formed as well as a method for forming a coated film containing such a thin film of silver mirror.

Another object of the present invention is to provide a method for forming a thin film of silver mirror good for the environment.

According to inventors' researches, the conventional method for forming a coated film by using the silver mirror reaction ordinarily provides a silver thin film in a thickness of not less than about 1 μm so as to hold a necessary reflective property in the metallic film obtained by the silver mirror reaction. When the thick film is formed in this manner, the coated film changes in color or the silver thin film itself suffers from delamination. Consequently, it is recognized that when the delamination of the silver layer occurs even if any coated film is formed, the durability of the coated film is deteriorated.

Then, the present inventors made various examinations on coated films in which the thickness of a silver mirror-thin film was decreased to around 0.01 μm to around 0.03 μm. Results revealed that the above problems can be solved by replacing the treating liquids used ordinarily in a two-liquid system with a three-liquid type one and mixing and using the three liquids at a prescribed timing.

Further, the following were clarified. That is, the metallic thin film formed in this manner looked to have luster and durability comparable to or better than those of the electroplated film obtained by electroplating. The coated light-transmitting film obtained by applying a light-transmitting resin-coated film has extremely high durability, so that the coated film can be applied to the surface treatment of automobile parts, etc. requiring heat resistance and weather resistance.

Further, the inventors confirmed that the thus formed silver mirror-thin film substantially no impurities such as sodium, whereas impurities such as sodium are detected in coated films having bad durability.

That is, a first aspect of the present invention is to provide a silver mirror-thin film forming method, comprising using silver mirror reaction-treating solutions comprising three solution: an ammoniacal silver salt aqueous solution (I), an aqueous solution of caustic soda (IIa) and an aqueous solution of a sugar-based or carbohydrate-based reducing agent (IIb) such as glucose (fructose), mixing said aqueous solution of caustic soda (IIa) and said aqueous solution of the reducing agent and immediately thereafter independently and simultaneously spraying the resulting mixed solution and said ammoniacal silver salt aqueous solution (I) onto an object to be coated, and thereby forming a thin film of silver mirror by depositing silver through a silver mirror reaction.

In the above, silver may be deposited with the silver mirror reaction by mixing the mixed solution (II) and the ammoniacal silver salt aqueous solution (I) and immediately after mixing, applying the mixture upon the object, e.g., by mixing the mixed solution (II) and the ammoniacal silver salt aqueous solution (I) immediately upstream of a nozzle of a spray and spraying the resulting mixed solution (III) onto the object.

When the mixed solution (II) is sprayed onto the object simultaneously and independently with the ammoniacal silver salt aqueous solution (I), the silver mirror reaction is carried out by mixing the mixed solution (II) and the ammoniacal silver salt aqueous solution (I) in a foggy state or through being diffused on a coated surface.

Thereby, the uniform and good thin film of silver mirror having a thickness in a range of 0.1 to 0.03 μm, for example can be formed.

In one embodiment, silver carbonate may be used in place of silver nitrate in the ammoniacal silver salt aqueous solution (I).

Furthermore, a second aspect of the present invention is to provide a coated film-forming method comprising the steps of forming said silver mirror-thin film on an object to be coated, and applying a coated film of a light-transmitting resin onto the silver mirror-thin film.

In addition, a third aspect of the present invention is to provide a coated film-forming method, comprising the steps of applying a layer of a primer resin on a surface of an object to be coated, forming said thin film of silver mirror on a surface of the primer resin layer by said silver mirror-thin film forming method, and forming a coated film of a light-transmitting resin on the silver mirror-thin film.

It is preferable that a coating material for forming the primer resin layer is substantially identical with that for forming the light-transmitting resin-coated film.

Further, according to a fourth aspect of the present invention, a coated film comprising a silver mirror-thin film substantially no sodium on a surface of an object to be coated and a film of a light-transmitting resin applied on an upper surface of the silver mirror-thin film is formed.

When the silver mirror-thin film substantially containing no impurities such as sodium is formed by the above silver mirror-thin film forming step and the coated film of the light-transmitting resin is applied on this thin film, durability of the coated film can be remarkably improved.

### BRIEF DESCRIPTION OF THE DRAWINGS

FIG. 1 is a diagram showing results in SPM measurement of a thin film of silver mirror 0 according to the present invention, in which an uneven shape of a surface of the silver mirror-thin film was measured.

FIG. 2 is a diagram showing an indication of profile in the measurement of FIG. 1.

FIG. 3 is a diagram showing results in SPM measurement of a thin film of silver mirror according to a comparative example, in which an uneven shape of a surface of the silver mirror-thin film was measured.

FIG. 4 is a diagram showing an indication of profile in the measurement of FIG. 3.

### BEST MODES FOR CARRYING OUT THE INVENTION

In the following, the silver mirror-thin film forming method according to embodiments of the present invention and silver mirror reaction-treating agents will be explained below in detail with reference to the drawings.

In the silver mirror-thin film forming method according to the present invention, three solutions: an ammoniacal silver salt aqueous solution (I), an aqueous solution of caustic soda (IIa) and an aqueous solution of a reducing agent (IIb) of a carbohydrate such as glucose (fructose) or the like are first prepared in applying a thin film of silver mirror onto a surface of an object to be coated.

As the object to be coated, various organic or inorganic materials may be recited by way of example. For example, any materials such as ceramics, metals and synthetic resins may be used, so long as they can be plated by so-called electroless plating. Among them, in order to exhibit the effectiveness of the light-transmitting coated film as one of the features of the present invention, the light-transmissible material is preferable as the object to be coated. As preferred synthetic resins, a polycarbonate-based resin, an ABS resin, an acrylic resin, etc. are recited by way of example. As the inorganic material, aluminum, stainless steel, etc. may be recited by way of example. A composite material such as a carbon graphite epoxy may be used.

In the present invention, the ammoniacal silver salt aqueous solution (I) deposits silver through reacting with the reducing agent. This is an aqueous solution in which an appropriate amount of the silver salt is dissolved with ammonia. As the typical ammoniacal silver salt aqueous solution (I), an ammoniacal silver carbonate aqueous solution and an ammoniacal silver nitrate aqueous solution are recited by way of example. Such an ammoniacal silver salt aqueous solution is preferably prepared by dissolving a predetermined amount of the silver salt in a given amount of pure water and further adding a predetermined amount of ammonia (NH₄ON) into the resulting solution. The aqueous solution (I) is generally prepared by dissolving silver nitrate into ammonia to obtain the ammoniacal silver nitrate aqueous solution and diluting the resulting ammoniacal silver nitrate aqueous solution with a desired amount of pure water. The inventors discovered that when the thickness of the silver mirror-thin film is decreased by the order of preparing the solutions, the performance of the silver mirror-thin film is influenced. It is difficult to obtain sufficient effects by obtaining the ammoniacal silver nitrate solution through dissolving the silver nitrate into ammonia and then diluting the ammoniacal silver nitrate solution with a given amount of pure water according to the conventionally ordinarily technique.

The concentration of the aqueous solution (I) is preferably low. For example, the concentration of this aqueous solution (I) is preferably in a range of 0.1 to 2% by mass, more preferably in a range of 0.5 to 1.0% by mass in terms of the concentration of silver. These concentration ranges correspond to 10 to 200 mmol/liter and preferably in a range of 40 to 100 mmol/liter in terms of the molar concentration. The ammoniacal silver salt aqueous solution (I) is usually preferably stored at not more than 25° and preferably not more than 20 C.° in a dark cold place under light shielding.

No limitation is posed upon the silver salt used. However, when silver nitrate is used, it is easier to produce a most reactive silver salt thin film with good durability. Herein, since an amount of oxides of nitrogen increases in a used liquid in the case that silver nitrate is used, denitrification treatment needs to be effected according to an appropriate method so as to discharge the used liquid into a sewer. It is an easy way that after the used liquid is decomposed with bacteria to make the concentration of the oxides of nitrogen not more than 120 ppm as the upper limit of the concentration of oxides of nitrogen as specified by Sewage Law, and discharged.

On the other hand, as to an example where silver carbonate is used, a good thin film can be produced by carefully controlling the three kinds of the solutions, although the reactivity is low. When silver carbonate is used, the embodiment is good for the environment, free from the problem that the concentration of nitrogen in the used liquid becomes higher and the method is good for the environment.

The aqueous solution of caustic sodium (IIa) is obtained by dissolving a predetermined amount of caustic sodium into pure water. The concentration of this solution is also low. For example, the concentration of caustic sodium is preferably in a range of 0.1 to 5% by mass, more preferably in a range of 1.0 to 2.0% by mass in terms of the concentration of caustic soda.

The reducing agent aqueous solution (IIb) is a solution obtained by dissolving a predetermined amount of a reducing agent carbohydrate-based reducing agent such as glucose, fructose, formalin (formaldehyde) or the like in pure water. This is a solution containing the reducing agent capable of depositing silver through reducing silver ions contained in the ammoniacal silver salt aqueous solution (I). As compared with formalin, the reducing agent of such as a sugar including glucose or fructose or a carbohydrate is gentler to the environment. The concentration of the reducing agent is not particularly limited, so long as it can deposit silver. The concentration is appropriately selected in a range of 1 to 10% by mass, depending upon the concentration of silver applied.

Each of the thus prepared solutions can be stored at not more than 25 and preferably not more than 20 C.° in a dark cold place under light shielding. The caustic sodium aqueous solution (IIa) and the reducing agent aqueous solution (IIb) are used in the form of a mixed solution (II) in which both of them are mixed together immediately before use. The caustic sodium aqueous solution (IIa) plays a role (starting function) to draw out a performance of the reducing agent aqueous solution (IIb) as the reducing agent. Therefore, according to the present invention, the caustic sodium aqueous solution (IIa) needs to be always mixed immediately before use.

When the caustic sodium aqueous solution (IIa) and the reducing agent aqueous solution (IIb) are preliminarily mixed and stored, it is difficult to obtain a good metallic thin film as desired, even if the components and the composition of the mixed solution (II) are identical. In addition, when the solutions are mixed in a different mixing order, it is also difficult to obtain a good metallic thin film as desired, even if the components and the composition of the mixed solution (II) are identical. Further, if the solution is exposed to a high temperature over 25° C., it is also difficult to obtain a good metallic thin film.

For example, when the preliminarily mixed solution (II) is left for a long time period as it is, the mixed solution (II) becomes more yellowish day by day, because components of the solutions seemingly react with each other. In the case of the conventional mixed solution in which a given amount of glucose is dissolved in an aqueous solution of caustic sodium becomes more yellowish with lapse of times and days through reacting. A thin film of silver mirror obtained by using the thus yellowish mixed solution (II) has poor durability. The bad durability is observed as lack of the silver film, peeling of silver grains, etc.

The mixed solution (II) obtained above is independently sprayed onto an object to be coated, simultaneously with the ammoniacal silver salt aqueous solution (I). When both the solutions (I) and (II) are simultaneously sprayed onto a surface of the object through separate nozzles, a double-headed gun or the like, they are almost uniformly mixed and deposit silver grains through a moderate reducing reaction. If the mixed solution (III) is formed by mixing both the solutions (I) and (II) immediately upstream a single nozzle, the mixed solution (III) may be sprayed onto the object through the single nozzle. In any case, a thin film of silver mirror can be formed in a thickness range of about 0.01 to 0.03 μm by adjusting the coated amount.

If the object to be coated is in a three-dimensional shape, the solutions are simultaneously sprayed onto its side face, too. That is, the object is preferably coated at one time over its entire coating face by spraying. Since each of the solutions (I) and (II) used in the present invention is dilute, it may be feared that the reaction speed is made lower accordingly. However, when the solutions are sprayed onto the entire object at one time, the coated film is dried and undergoes a faster reaction, for example, even at an edge portion, so that the coated film can be prevented from becoming brownish-red. In this case, the solutions do not stay even in a portion, such as the edge portion, where non-reacted liquids are likely to stay, when the solutions are sprayed onto the entire object at one time. Consequently, the color of the silver mirror-thin film can be prevented from changing to brownish-red.

The thin film of silver mirror having high durability and good luster is formed in a thickness of about 0.1 to 0.03 μm on the surface of the object as mentioned above.

In the light-transmitting coated film-producing method according to the present invention, a coated light-transmitting film (hereinafter referred to as “coated film” or “clear layer”) is formed on the above silver mirror-thin film. No particular limitation is posed upon the coated light-transmitting film so long as it does not damage the properties of the silver mirror-thin film. For example, a clear coating of an acryl resin type, a urethane resin type or the like may be applied by spraying. These resin coating materials may be colored by incorporating an appropriate amount of a dye in such a range as not damaging the properties of the silver mirror-thin film.

No limitation is posed upon the thickness of the clear layer. Such a thickness as to impart smoothness upon the clear layer formed on the silver mirror-thin film is preferred. Since the silver mirror-thin film has minute uneven portions at the surface, such unevenness is preferably smoothened. The thickness is ordinarily preferably 5 to 30 μm.

In the present invention, as the object to be coated, an object to be primarily provided at its surface with a primer resin layer is used.

No limitation is posed upon the thickness of the primer resin layer, but the thickness of 5 to 30 μm is ordinarily preferred. No limitation is posed upon the condition for the provision of the primer resin layer, either, and a coating method ordinarily used may be employed as it is. Touching is prohibited after the treatment with the primer, because a mark is left on the primer layer if it is directly touched with a hand.

Durability of the thin film of silver mirror is drastically improved by using the object provided with the primer resin layer. For example, as compared with a case where no primer-providing step is performed, peeling resistance is enhanced to about 8 times in case that the primer-providing step is appropriately performed. As the primer giving such a peeling resistance, the same material as the coating material applied to the clear layer may be recited by way of example. For example, the primer is an acrylic resin type, an urethane resin type or the like, which is applied to the object by spraying.

Although the cause for the above is not clear, it is presumed as follows. That is, since the thickness of the silver mirror-thin film is so sufficiently small in the present invention as to visually produce luster obtained through reflection of light. However, the silver mirror thin layer has microscopically minute uneven portions, and durability of the silver mirror-thin film is enhanced through development of a firm adhesion between the silver mirror-thin film and the resin applied to the clear layer. From this point of view, the average thickness of the silver mirror-thin film is controlled preferably in a range of 0.005 to 0.1 μm, more preferably in a range of 0.01 to 0.05 μm, particularly preferably in a range of 0.01 to 0.03 μm. Too small average thickness makes it difficult to produce sufficient luster. On the other hand, thicker average thickness makes the durability of the coated film of the light-transmitting resin insufficient.

This thin film is preferably provided larger uneven portions as compared with the average thickness. Herein, the average thickness is the thickness obtaining by averaging the minute uneven portions. As mentioned in Examples mentioned later, “larger uneven portions” means that if the average thickness is 20 nm, for example, the maximum vertical differences beyond 20 nm. By forming the silver mirror-thin film like this, the peeling resistance can be increased to about 4 to 5 times.

According to the present invention, the tougher coated film of the light-transmitting resin can be formed when the substantially same resin component used in the optimum primer resin layer is used as the resin component in the clear layer. In this case, the light-transmitting resin coated film is less peelable and has higher adhesion. A so-called anchor effect in which the clear layer is rooted in the uneven portions of the silver mirror-thin film can be obtained.

An activating step in which the primer resin layer is activated according to an appropriate technique is preferably involved before forming this silver mirror-coated film.

Since the silver mirror-thin film thus obtained has high durability, it is less cracked even if the base material is a flexible material such as a rubbery material.

Further, since it is expected that the silver mirror-thin film not only reflects light at the silver surface but also can freely pass light rays because of its small thickness. If the thickness is more than 0.1 μm, no light ray generally pass the film. Since the thin film is formed as mentioned above, it passes infrared rays, too. Thus, if an infrared ray-transmittable object to be coated is used, the resultant plate can be used as a front face plate of an optical sensor to be actuated with infrared rays.

Although the features of the present invention have been explained, concrete coated light-transmitting films can be obtained in the present invention by providing the ordinary silver mirror-coating step. With respect to one example thereof, steps of forming a coated light-transmitting film on a synthetic resin material selected as an object to be coated will be successively explained.

1) Dewaxing Step

Isopropanol (IPA) or another alcohol is selected, depending upon the material, and is dewaxed by using a fibrous material (cloth) such as an anticorrosive cloth.

2) Air Blow State

Thread dust, particulate dust, static electricity, etc. are removed by blowing the material with air at an air pressure of around 4±1 Pa.

3) Primer Step

The primer is coated to give a coated thickness of 20 μm. The primer coating is carried out for conditioning the surface of the resinous object to be coated.

In order to plate ordinary ABS with chromium, butadiene units are etched with an acid, and then activating treatment is performed with tin chloride or palladium. When a modified acrylic silicone coating material (manufactured by ADVANCE COMPANY, LTD.) or an acryl urethane-based primer, for example, is selected as the primer, no etching is necessary. Such primers are used for the clear layer, too.

4) Drying Step

A coated primer film is cured by heating at an appropriate temperature (for example, 40 to 80° C.) and drying for a given time period (for example, few dozens minutes to several hours) after coating.

5) Surface-Activating Step

The surface-activating agent is uniformly sprayed onto the entire coated surface. In this case, it is important to apply the solution of the activating agent such that it may not be dried and that any edge portion is finally coated. As the ordinary activating agent, a base solution containing a metal (tin) is used, for example.

6) Washing Step

Before the activating agent solution is dried, an excess amount thereof is washed away with pure water to which an appropriate water pressure is applied.

7) Silver Mirror-Forming Step

Both the solutions (I) and (II) are simultaneously applied to the entire coating surface substantially uniformly, or immediately after both the solutions (I) and (II) are mixed, the resulting mixture is coated or sprayed onto the surface.

With respect to a three-dimensional object having a vertical face and a flat face, according the conventional silver mirror-forming step, spraying is carried out for the vertical face and the flat face at a ratio of 2:1, because the reaction time differs therebetween. According to the present invention, however, spraying is so effected that a thin film of silver mirror may be substantially uniformly in a desired thickness onto the entire coating surface. Thereby, the uniform and good silver mirror-thin film can be obtained, while no black stain appears at the edge portion where it is difficult to attach the liquid. The silver film is substantially uniformly formed on the surface of the object to be coated, while silver ions are reduced over the entire coating surface.

8) Washing Step

Excess solutions (I) and (II) are washed away with water. The washed object is finally washed with pure water.

9) Liquid Blow-Away Step

In order to prevent the water from returning, the liquid is blow away with air from one side of the object as in sweeping with a brush.

10) Drying Step

The coated object is dried at an appropriate temperature.

11) Clear Coating Step

Clear coating is carried out to give a thickness of around 15 μm. A colorant is added into the main material, if appropriate. How the clear layer gets on in this clear coating step largely differs, depending upon the method for forming the silver mirror-thin film. Only according to the silver mirror-forming step to meet the present invention, the firm clear layer is provided.

Effects of the present invention will be concretely explained below according to specific examples, but the invention is not limited to those examples.

### EXAMPLE 1

Into 20 liters of pure water was dissolved 200 g of silver nitrate Ag₂NO₃, and then a liquid I was prepared by adding 1130 g of ammonia NH₄OH to the resultant. A liquid IIa was prepared by dissolving 160 g of glucose (1st grade reagent) into 20 liters of pure water. A liquid IIb was prepared by dissolving 200 g of sodium hydroxide (1st grade reagent) into 20 liters of pure water. Each liquid was stored in a dark cold place at not more than 20° C.

A commercially available thin plate of an ABS resin: light-transmitting resin product was used as a sample, and the sample (thin resin plate) was dewaxed with isopropanol. Then, thread dust and fine particles attached to the surface was removed by blowing with air.

Further, a modified acrylic silicone coating material (manufactured by ADVANCE COMPANY, LTD.) was sprayed at an air pressure of 3 Pa to form a primer coat at the average film thickness of 20 μm, and the primer coat was dried at 80° C. after being left at room temperature for around 10 to 20 minutes. The modified acrylic silicone coating material (manufactured by ADVANCE COMPANY, LTD.) had a compounding ratio of 3.50 g of a main agent, 2.5 g of a curing agent, 2.5 g of a thinner and 0.25 g of an additive (a curing reaction aid). The modified acrylic silicone coating material contained isocyanate groups. It was confirmed by the measurement of infrared spectra at a wavelength of 2270 cm⁻¹ that those isocyanate groups were consumed with progress in the polymerization reaction during the step of providing the primer resin layer.

After a surface-activating liquid (20 g/liter of tin chloride, 10 g/liter of palladium chloride and 70 g/liter of hydrogen chloride) was sprayed onto the surface of the primer-coated object by using an air gun until the entire surface was wetted, the activating liquid was washed away by spraying water, thereby obtaining an object to be coated.

Immediately after the above liquids IIa and IIb preliminarily prepared were mixed at an equal ratio, the mixed liquid was charged in a coating machine (double-headed gun) having two nozzles together with the liquid I, and spray coating was began. At that time, the amounts of the liquids I and II sprayed through the respective nozzles were equal to each other. Each of the liquids was uniformly sprayed, without irregularity, so that the liquids may be mixed on the surface of the object to be coated. In this spraying, the air pressure was set at 1.5 Pa, and the spraying time period was 2 minutes.

Liquid-storing containers and pipes of the coating machine (double-headed gun) need to be all composed of materials not reactable with the chemical liquids. They are preferably coated with a resin such as Duracon.

After spraying, an excess amount of each liquid was washed away with water, water was removed with air (air pressure 4 Pa), and the coated object was dried at 65° C. for 10 to 20 minutes. Observation with a 200-power optical microscope recognized the good surface smoothness, and no chipping (peeling) of the silver film at edge portions.

Finally, a clear coating was performed such that the modified acrylic silicone-based coating material (ADVANCE COMPANY, LTD.) was sprayed at an air pressure of 3 Pa to give a coated film thickness of 15 μm to 20 μm.

The coated object had a metallic appearance, but had around 40 to 70% of the light transmittance of the non-treated sample.

With respect to the used liquid, it was confirmed that oxides of nitrogen specified in the Sewage Law were decomposed by maintaining it in an aerobic condition added with an oxygen-microorganism preparation manufactured by Nippon Soda Co., LTD. (Trade name: Mikedan AD) Thus, the used liquid can be discharged to sewage lines as it is.

In 1 g of this preparation, not less than 1,000 million of aerobic bacteria (oxygen-generating and flock-forming bacteria) and various enzymes (amylase, protease, lipase, cellulase, etc.) produced in a cultivating step are mixed. The enzymes function to decompose organic materials in the used liquid, and help the aerobic bacteria and the activated sludge bacteria propagate. The aerobic bacteria contained in this preparation function to improve the flocked state and the living environment of the activated sludge microorganisms.

### COMPARATIVE EXAMPLE 1

For comparison purpose, a predetermined amount of a liquid in which the liquids IIa and IIb were mixed and stored or a liquid having the same components was used and sprayed in the same manner as in Example 1, thereby obtaining a silver mirror-thin film. In this case, the liquid II was yellowish, and the resultant silver mirror-thin film had no clear silver film, but the silver film became blackish. The resulting silver mirror-thin film was washed with water, and water was removed at air pressure of 4 Pa. Observation with the 200-power optical microscope revealed that almost all of the silver film was peeled.

When a thick silver mirror film (film thickness 0.1 to 0.3°, for example) was prepared by using liquids in which the concentration of each ingredient was increased, a uniform and clear silver mirror film could be obtained.

This confirmed that apparent control of the film thickness is possible but no firm silver mirror-thin film cannot be obtained, merely when the concentration of the conventional silver mirror liquid is decreased in forming the silver mirror-thin film. That is, it was confirmed that even when the ingredients and their concentrations of the silver mirror liquid are same but the thickness of the silver mirror-thin film is small, difference in the preparation methods cause great differences in the formation of the thin films.

Then, similarly with Example 1, a clear layer was provided on the silver mirror film (for example, film thickness 0.1 to 0.3 μm). A coated silver mirror film, which looked to have the same luster as that in Example 1, was obtained. The light transmittance of this silver mirror-thin film was low.

Peeling Resistance Test and Discussions

The coated films in Example 1 and Comparative Example 1 were subjected to peeling tests. The coated film of Comparative Example 1 had peeling resistance of 2.0 N/cm², and the coated film in Example 1 of the present invention had peeling resistance of 9.8 N/cm². That is, the peeling resistance was increased about 5 times by forming the silver mirror according to the present invention.

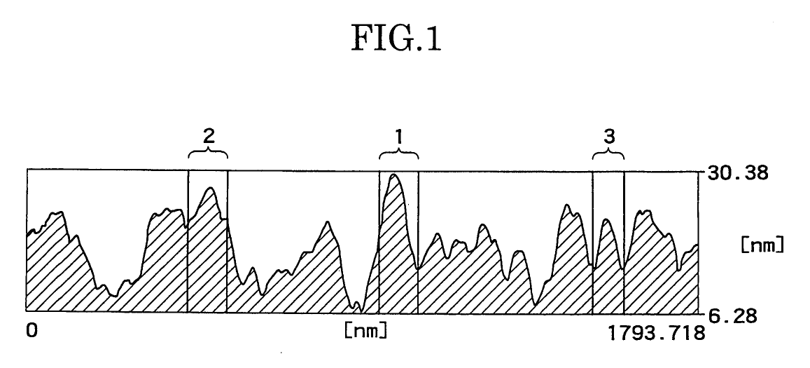

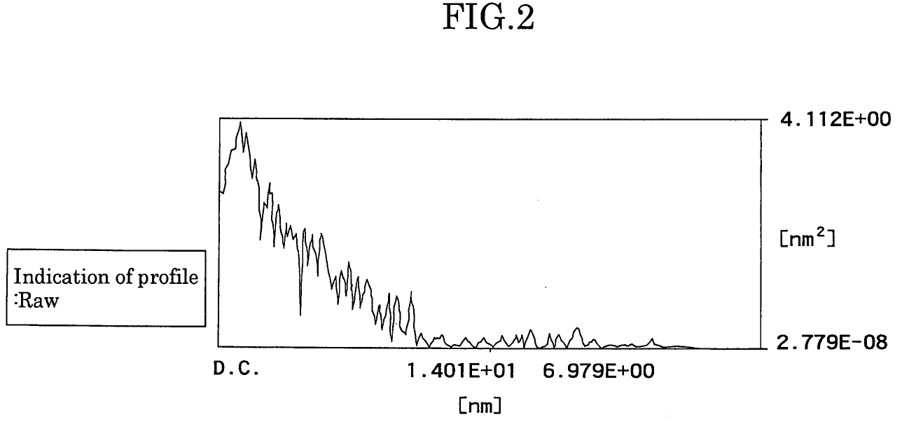

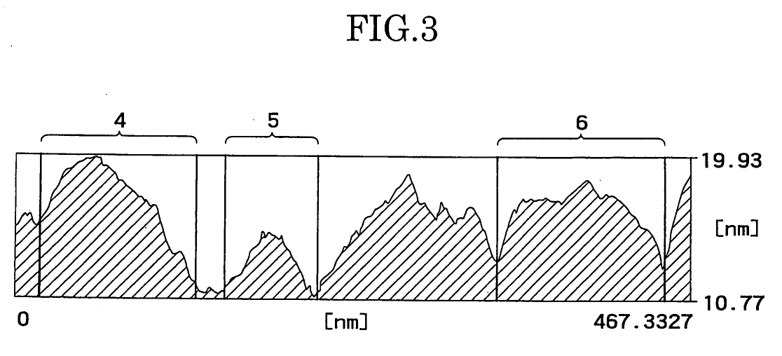

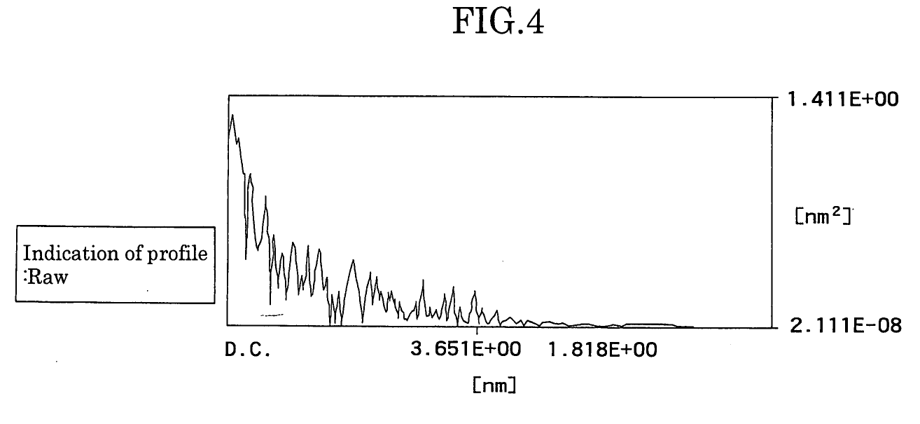

In order to presume causes for this, fine three-dimensional shapes of the surfaces of the silver mirror-thin films obtained in Comparative Example 1 and Example 1 were measured with an SPM (scanning type probe microscope). Results are shown in FIGS. 1 to 4, Tables 1 and 2 and below. Cluster Nos. in Tables 1 and 2 correspond to those in FIGS. 1 and 3.

### COMPARATIVE EXAMPLE 1

Center-line average roughness: 1.226E+00 nm
Maximum height difference: 9.311E+00 nm
n-point average roughness: 4.480E+01 nm (10 points)
Measured length: 4.637E+02 nm
Cutoff value: 1.546 E+02 nm
Average inclined angle: 8.034E+00°
Center-line average roughness: 4.573E+00 nm
Maximum height difference: 2.406E+01 nm
n-point average roughness: 1.677E+01 nm (10 points)
Measured length: 1.780E+03 nm
Cutoff value: 5.932E+02 nm

Average inclined angle: 8.538E+00°

TABLE 1

| Cluster | | | Difference in | Distance in | Difference |
|---|---|---|---|---|---|
| No. | Z1[nm] | Z2[nm] | height[nm] | height[nm] | in angle[°] |
| 1 | 18.42664 | 13.68529 | 4.741349 | 105.3063 | 2.577965 |
| 2 | 21.16941 | 21.63342 | 0.464014 | 105.3063 | 0.252462 |
| 3 | 14.62138 | 13.93157 | 0.689629 | 84.24505 | 0.469012 |

TABLE 2

| Cluster | | | Difference in | Distance in | Difference |
|---|---|---|---|---|---|
| No. | Z1[nm] | Z2[nm] | height[nm] | height[nm] | in angle[°] |
| 4 | 15.63861 | 11.65954 | 3.979066 | 107.9163 | 2.111640 |
| 5 | 11.33027 | 10.87431 | 0.455966 | 64.93272 | 0.402332 |
| 6 | 13.16604 | 13.19344 | 0.027400 | 117.0618 | 0.013411 |

Since the silver film was peeled when the silver mirror-thin film according to Comparative Example 1 was washed with water, the sample not washed with water was observed. With respect to the silver mirror-thin film according to Comparative Example 1, it was observed that a length in a horizontal sectional face was in a range of 60 to 120 nm, the maximum height difference was 9.3 nm, and silver clusters having low thickness-direction heights (surface unevenness) were deposited in the thickness direction.

To the contrary, with respect to the silver mirror-thin film according to the present invention, it was observed that a length in a horizontal sectional face was in a range of 80 to 110 nm (about 100 nm on the average), and silver clusters having the maximum height difference of 24 nm, i.e., larger height difference in thickness direction (larger unevenness) were deposited in the thickness direction. It is presumed that the structure having such a fine and larger height difference with large unevenness affords increased peeling resistance of the coated film with the clear layer (coated light-transmitting film).

Further, impurities such as sodium were detected in the silver mirror-thin film according to Comparative Example 1, whereas no such impurities were detected in the silver mirror-thin film according to the present invention. This is presumed such that sodium was contained as impurity in the silver clusters of the silver mirror-thin film because of the improper silver mirror-treating liquid, which weakened the strength of the silver mirror-thin film.

This presumption was supported as follows. After the coated light-transmitting film was formed on the silver mirror-thin film and then the coated film was mechanically peeled, the surface was measured by the XPS. As a result, much silver was deposited on the surface of the silver mirror-thin film according to the present Example, whereas much impurities such as sodium were detected as to the silver mirror-thin film according to Comparative Example.

### EXAMPLE 2

In Example 1, immediately after given amounts of the respective three liquids I, IIa and IIb were mixed, the mixture was sprayed by a spray with a single nozzle. As a result, a coated light-transmitting film could be almost uniformly obtained as in Example 1 in case that the coated area was small.

### EXAMPLE 3

Silver mirror-thin films were obtained, while the temperature of each liquid was changed in a range of 10° C. to 40° C. When the liquid temperature was suppressed to not more than 25° C., good silver mirror-thin films could be obtained even when relatively large areas were coated. In the case of large-area coating at more than 25° C., it was difficult to obtain an uniform silver mirror-thin film. The film was partially cloudy or blackish brown.

The above confirmed that the coating is preferably performed in an atmosphere controlled to not more than 25° C. in the case of mass production.

### EXAMPLE 4

Into 20 liters of pure water was dissolved 200 g of silver carbonate Ag₂CO₃, and a liquid I was prepared by adding 1130 g of ammonia NH₄OH to the solution. Thereafter, a silver mirror-thin film and a coated light-transmitting film were formed in the same manner as in Example 1. The resulting coated light-transmitting film was light-transmittable, and had sufficient peeling resistance.

In this case, since the used liquid contained a small amount of nitrogen components, it could be discharged into a sewage line as it was.

### EFFECTS OF THE INVENTION

As mentioned above, the present invention can provide the silver mirror-thin film forming method which forms the silver mirror-thin film having good durability, without coloring or change in color, even when the coated film is formed. The invention can also provide the method for the formation of the coated film containing this silver mirror-thin film. In addition, the silver mirror-thin film forming method and the method for the formation of the coated film containing this silver mirror-thin film have a practically useful effect that they are good for the environment.

1-10. (canceled)

11. A silver mirror-thin film forming method, comprising preparing a silver mirror reaction-treating solution comprising three solutions: an ammoniacal silver salt aqueous solution, an aqueous solution of caustic soda and an aqueous solution of a reducing agent, mixing said aqueous solution of caustic soda and said aqueous solution of the reducing agent to obtain a mixed liquid, independently and simultaneously spraying the mixed liquid and said ammoniacal silver salt aqueous solution onto an object to be coated, or mixing said mixed liquid with said ammoniacal silver salt aqueous solution to obtain a mixed liquid and applying the mixed liquid onto the object, and thereby forming a silver mirror-thin film by depositing silver through a silver mirror reaction to provide the silver mirror-thin film on a surface of the object.

12. The silver mirror-thin film forming method set forth in claim 11, wherein said ammoniacal silver salt aqueous solution is an ammoniacal silver nitrate aqueous solution.

13. The silver mirror-thin film forming method set forth in claim 11, wherein said ammoniacal silver salt aqueous solution is an ammoniacal silver carbonate aqueous solution.

14. The silver mirror-thin film forming method set forth in claim 11, wherein said ammoniacal silver salt aqueous solution contains silver in a range of 0.5 to 2.0% by mass, and said caustic soda aqueous solution contains sodium in a range of 0.5 to 2.0% by mass.

15. A coated film-forming method comprising the steps of forming a silver mirror-thin film on a surface of an object to be coated, by said silver mirror-thin film forming method set forth in claim 11, and applying a coated film of a light-transmitting resin onto the silver mirror-thin film.

16. A coated film-forming method, comprising the steps of applying a layer of a primer resin on a surface of an object to be coated, forming a thin film of silver mirror on a surface of the primer resin layer by said silver mirror-thin film forming method set forth in claim 11, and forming a coated film of a light-transmitting resin on the silver mirror-thin film.

17. The coated film-forming method set forth in claim 16, wherein a coating material for forming the primer resin layer contains a substantially identical resin component as that of a coating material for forming the light-transmitting resin coated film.

18. The coated film-forming method set forth in claim 16, which comprises a step of activating the primer resin layer before the formation of the silver mirror coated film.

19. The coated film-forming method set forth in claim 15, wherein said object to be coated has light transmissibility.

20. A coated film comprising a thin film of silver mirror on a surface of an object to be coated, said silver mirror-thin film containing substantially no sodium, and a coated film of a light-transmitting resin provided on an upper surface of the silver mirror-thin film.

21. The silver mirror-thin film forming method set forth in claim 12, wherein said ammoniacal silver salt aqueous solution contains silver in a range of 0.5 to 2.0% by mass, and said caustic soda aqueous solution contains sodium in a range of 0.5 to 2.0% by mass.

22. The silver mirror-thin film forming method set forth in claim 13, wherein said ammoniacal silver salt aqueous solution contains silver in a range of 0.5 to 2.0% by mass, and said caustic soda aqueous solution contains sodium in a range of 0.5 to 2.0% by mass.

23. A coated film-forming method comprising the steps of forming a silver mirror-thin film on a surface of an object to be coated, by said silver mirror-thin film forming method set forth in claim 12, and applying a coated film of a light-transmitting resin onto the silver mirror-thin film.

24. A coated film-forming method comprising the steps of forming a silver mirror-thin film on a surface of an object to be coated, by said silver mirror-thin film forming method set forth in claim 13, and applying a coated film of a light-transmitting resin onto the silver mirror-thin film.

25. A coated film-forming method comprising the steps of forming a silver mirror-thin film on a surface of an object to be coated, by said silver mirror-thin film forming method set forth in claim 14, and applying a coated film of a light-transmitting resin onto the silver mirror-thin film.

26. The coated film-forming method set forth in claim 16, wherein said object to be coated has light transmissibility.

27. The coated film-forming method set forth in claim 17, wherein said object to be coated has light transmissibility.

28. The coated film-forming method set forth in claim 18, wherein said object to be coated has light transmissibility.
